(19) United States
(12) Patent Application Publication
(10) Pub. No.: US 2014/0375748 A1
(43) Pub. Date: Dec. 25, 2014

(54) ELECTRONIC DEVICE

(71) Applicant: Yuji Kamon, Osaka-shi (JP)

(72) Inventor: Yuji Kamon, Osaka-shi (JP)

(73) Assignee: SHARP KABUSHIKI KAISHA, Osaka-shi, Osaka (JP)

(21) Appl. No.: 14/365,435

(22) PCT Filed: Aug. 30, 2012
(86) PCT No.: PCT/JP2012/072028

§ 371 Date: Jul. 10, 2014

(30) Foreign Application Priority Data
Dec. 16, 2011 (JP) 2011-276153

(51) Int. Cl. G06F 9/50; H04N 5/44; H04N 7/14

(52) U.S. Cl. CPC G06F 9/5083; H04N 7/141; H04N 5/4403
USPC 348/14.03; 718/104

(57) ABSTRACT

In order to impart comfort with operations to users, an electronic device allowing comprehensive consideration of resource conditions that have an impact on response time for operations has been sought. Therefore, an electronic device comprising an operation input unit, an execution unit for implementing relevant device functions, device resources used via operations of the operation input unit and the execution unit in a shared manner, a virtual processing unit for executing processes to be executed using the device resources via operations of the operation input unit without actual inputs in an intermittent manner, and a time measurement unit for measuring virtual operation processing time required for execution via the virtual processing unit is proposed.

### BACKGROUND OF THE INVENTION

1. Field of the Invention

The present invention relates to an electronic device for virtually measuring operation processing time for operation inputs.

2. Description of the Related Art

Resources necessary for operating electronic devices (e.g., CPU processing speed, memory capacity, hard disk capacity, and the like) are limited. Therefore, when multifunctions for electronic devices operate in a parallel manner, resource distribution becomes problematic. In particular, video communication functions have been installed in various equipment, such as TVs and cell phones. However, the total loads applied to electronic devices when video communication functions are used are different from those when communication functions are not used, for example. In such cases, even when users perform the same operations (e.g., remote control inputs), response time for users' operations (e.g., the time following the pushing of remote control arrow keys until cursors actually move) fluctuates. More specifically, when using video communication functions, response time is delayed after remote control inputs occur. Such response time delays can make users uncomfortable.

According to the invention disclosed in the following Patent Reference 1, in relation to teleconference systems, terminals measure their own CPU loads and acquire the resulting information. Furthermore, CPU load information as well as video encoded data are transmitted and received. At the same time, when it is determined through comparison whether or not CPU load information (from the transmitting side and the receiving side) is higher than a predetermined threshold, encode parameters are adjusted based on the results of such comparison (see paragraph 0015).

### Patent Reference 1: Unexamined Japanese Patent Application Publication No. 2011-29868

### SUMMARY OF THE INVENTION

### Problems to be Solved by the Invention

The standard used to determine whether users feel comfortable or uncomfortable with operations is response time for operations. CPU load (i.e., CPU utilization rate) is not the only factor that influences response time for operations. It is also necessary to consider resource conditions other than CPU utilization rate, such as RAM bandwidth usage rate and HDD data transmission quantity. According to the prior art of Patent Reference 1, it has not been disclosed that situations for usage of resources other than CPU load information (i.e., CPU utilization rate) should be considered.

Therefore, in order to impart comfort with operations to users, an electronic device allowing comprehensive consideration of resource conditions that have an impact on response time for operations has been sought.

### Means for Solving the Problems

In order to solve the above deficiencies, the applicant proposes the following electronic device.

That is to say, a first aspect of the invention proposes an electronic device comprising an operation input unit, an execution unit for implementing relevant device functions, device resources used via operations of the operation input unit and the execution unit in a shared manner, a virtual processing unit for executing processes to be executed using the device resources via operations of the operation input unit without actual inputs in an intermittent manner, and a time measurement unit for measuring virtual operation processing time required for execution via the virtual processing unit.

A second aspect of the invention proposes the electronic device according to the first aspect of the invention further comprising an operation processing time comparison unit for comparing the virtual operation processing time measured via the time measurement unit with operation processing time as target time during which the processes inputted via the operation input unit and via the device resources are executed and a load control unit for distributing relevant resources based on the result of comparison via the operation processing time comparison unit.

A third aspect of the invention proposes the electronic device according to the second aspect of the invention further comprising a target operation processing time setup unit with functions for establishing the target operation processing time.

A fourth aspect of the invention proposes the electronic device according to any one of the first to the third aspects of the inventions, wherein the operation input unit comprises an input device.

A fifth aspect of the invention proposes a television receiver including the electronic device according to any one of the first to the fourth aspects of the inventions.

A sixth aspect of the invention proposes the electronic device according to any one of the first to the fourth aspects of the inventions, wherein functions of the television receiver are television receiving and output functions.

### Advantageous Effect of the Invention

According to the present invention, an electronic device allowing comprehensive consideration of resource conditions that have an impact on response time for operations can be provided. For example, it is possible to impart comfort with operations to users with the use of the corresponding technology.

### DETAILED DESCRIPTION OF THE INVENTION

Embodiments of the present invention will be described hereinafter with reference to the attached drawings. The present invention is not limited to the above embodiments and may be embodied in various forms without exceeding the scope thereof. A first embodiment will mainly describe claims 1, 4, 5, and 6. A second embodiment will mainly describe claim 2. A third embodiment will mainly describe claim 3. Additionally, a first practical example represents an example in which the present invention applies to a digital TV with video communication functions.

### First Embodiment

### Concept of First Embodiment

An electronic device of a first embodiment is characterized in that it allows comprehensive consideration of resource conditions that have an impact on response time for operations via measurement of virtual operation processing time for virtual operation inputs.

### Functional Configuration of First Embodiment

FIG. 1 is a diagram explicating an example of a functional block for the electronic device of the first embodiment. The functional configuration for the electronic device of the first embodiment is explained with reference to this figure.

The electronic device (0101) of the first embodiment comprises an “operation input unit” (0102), an “execution unit” (0103), “device resources” (not shown in the figure), a “virtual processing unit” (0104), and a “time measurement unit” (0105).

The “operation input unit” has functions that allow operation inputs for the electronic device. For example, the operation input unit may include an input device or devices, such as a remote control unit, a keyboard, or and/or a mouse. The operation input unit may also include an input terminal that allows reception of operation data via connection with another terminal

The “execution unit” implements device functions. For example, the execution unit executes various programs in order to implement video communication functions. Device functions may be television receiving and output functions. In such case, measurement of the virtual operation processing time, which is described below, includes processing to be executed via device resources to be utilized via the execution unit in order to implement television receiving and output functions.

The “device resources” are resources commonly used by operations via the operation input unit and the execution unit. The reason why resources “commonly used” are constituent features is described as follows. That is to say, if operations take place via the operation input unit using device resources independently of those of the execution unit, operation processing time will become fixed, regardless of what device functions are implemented via the execution unit. Therefore, there will be no problems posed by the present invention.

The “virtual processing unit” has a function to implement processing commands inputted via the operation input unit that are executed via the device resources mentioned above without actual inputs in an intermittent manner. The term “in an intermittent manner” refers to a manner that is not necessarily limited to those by which processing takes place at approximately equivalent time intervals, and even includes manners by which processing takes place “on a regular basis.” That is to say, the intervals at which virtual processing takes place may be short or long. Virtual processing may be repeated back-to-back without intervals in some cases. In addition, it goes without saying that in actuality there are cases in which a single instance of processing can take place without the repetition of such virtual processing.

A specific example of “processing commands inputted via the operation input unit that are executed via the device resources” includes the user interface processing described below, for example.
<1> A pointer on a screen is moved by moving a mouse.
<2> A GUI icon is selected by clicking the left mouse button.
<3> A browser is closed by clicking a close button on a window via a mouse.
<4> An edit menu is displayed by clicking the right mouse button.
<5> Screen scrolling is initiated by dragging a scroll bar via a mouse (or rotating a mouse wheel).
<6> A file operation, such as file copying, is performed by dragging-and-dropping with a mouse.
<7> A cursor is moved via a keyboard.
<8> Text is inputted via a keyboard.
<9> Sound volume is turned up (or turned down) by pressing a remote control sound volume button.
<10> A channel is changed by pressing a remote control channel button.
<11> A GUI icon is selected by touching a touch panel with a finger.
<12> Text is inputted through voice input via a microphone.

In relation to virtual inputs that are processed via the virtual processing unit, some or all of the operation inputs that can be inputted via the operation input unit are acceptable. When the quantity of operation inputs to be virtually processed becomes excessively large, the rate of reaction is delayed due to such virtual processing. Problems such as loss of comfort with operations may occur. Therefore, it is preferable to limits virtual inputs to representative operation input examples. Based on the type of programs that are executed in real time via the execution unit and information about the most recent users' inputs, etc., it is particularly preferable to virtually input representative operation inputs that can be easily performed under the corresponding situation are particularly preferable. Therefore, it is desirable to retain a table of combinations of electronic device action patterns (e.g., those taking place at the time of execution of television viewing programs) and representative operation inputs that can be easily performed under the corresponding situation (e.g., changes to sound volume and channel via a remote control) so that such table can be used via the virtual processing unit.

Outputs to users are not required for processing performed via the virtual processing unit. Thus, some actual processing may not take place, such as drawing processing.

The “time measurement unit” measures virtual operation processing time required for execution via the virtual processing unit. More specifically, the variance between the processing commencement time (the time at which virtual inputs took place) and the processing completion time (the time at which execution of such virtual inputs was completed) occurring in the virtual processing unit is measured. Furthermore, the average of the measurement results mentioned above is computed, and such average processing time may be obtained as the virtual operation processing time.

Specific examples of “virtual operation processing time” measured via the time measurement unit are described as follows.
<1> In case that a pointer on a screen is moved by moving a mouse, the time from commencement of movement of the mouse until the pointer on the screen starts to move
<2> In case that a GUI icon is selected by clicking the left mouse button, the time until the GUI icon is selected following the left click
<3> In case that a browser is closed by clicking a close button on a window via a mouse, the time from the clicking until the browser completion processing starts
<4> In case that an edit menu is displayed by clicking the right mouse button, the time until display of the edit menu commences following the right clicking
<5> In case that a screen scrolling is initiated by dragging a scroll bar via a mouse (or rotating a mouse wheel), the time until the screen scrolling starts following the dragging (or following commencement of rotating the mouse wheel)
<6> In case that a file operation, such as file copying, is performed by dragging-and-dropping with a mouse, the time until file copying commences following the dragging-and-dropping
<7> In case that a cursor is moved via a keyboard, the time until the cursor moves following the pushing of the keyboard keys
<8> In case that text is inputted via a keyboard, the time until the text is displayed following the pushing of the keyboard keys
<9> In case that sound volume is turned up (or turned down) by pressing a remote control sound volume button, the time until the sound volume is turned up (or turned down) following the pushing of the sound volume button
<10> In case that a channel is changed by pressing a remote control channel button, the time until the channel is changed following the pushing of the channel button
<11> In case that a GUI icon is selected by touching a touch panel with a finger, the time until the icon is selected following the touching of the touch panel with the finger
<12> In case that text is inputted through voice input via a microphone, the time until the text is displayed following the detection of voice input via the microphone

### Television Receiver

The present invention also contains a television receiver including the electronic device of the first embodiment. The television receiver retains a function for receiving broadcasted content data (receiving function) and a function for outputting the received content data that can be viewed on the display, in addition to the functional configurations of the electronic device of the first embodiment described above.

### Hardware Configuration of First Embodiment

Subsequently, hardware configuration of the electronic device of the first embodiment is explained. FIG. 2A and FIG. 2B are schematic diagrams showing an example of a hardware configuration of the electronic device of the first embodiment. As shown in such figures, the electronic device of the first embodiment comprises a “CPU” (0201), a “main memory” (0202), a “storage unit” (0203), and an “I/O” (0204). Such components are mutually connected through a data communication path, such as a “system bus” (0205), thereby allowing transmission/reception and processing of information to be carried out. Furthermore, the electronic device of the first embodiment may also comprise a “GPU” (0206), a “video memory” (0207), an “I/O” (0208), and a data communication path, such as a “graphic bus” (0209), by which the aforementioned components are mutually connected.

The storage unit stores various programs executed by the CPU. Additionally, the main memory provides working area as an operational area upon execution of the programs by the CPU. Moreover, a plurality of memory addresses are assigned to such main memory and storage unit, respectively. Such memory addresses are specified and accessed through programs executed via the CPU, thereby allowing mutual exchange of data and relevant processing. Furthermore, it is acceptable to perform graphic processing via the GPU, video memory, or the like.

When the power for a display unit of the first embodiment is turned on, programs, such as an operation input program, an execution program, a virtual processing program, and a time measurement program, are deployed in the main memory. Furthermore, programs for graphic processing, such as a drawing program 1 and a drawing program 2, are deployed in the video memory.

The CPU, which is a part of the operation input unit, confirms in an intermittent manner whether or not operation inputs from the input device connected with the I/O take place in accordance with the operation input program deployed in the main memory and accepts operation input information.

The CPU, which is a part of the execution unit, executes various types of processing for implementing of device functions in accordance with the execution program deployed in the main memory. The execution program may constitute a plurality of programs instead of a single program, such as in cases in which a device retains a plurality of functions. When operation inputs are accepted via the operation input unit, inputted operations can be implemented in accordance with the execution program based on the inputted operation input information.

The CPU which is a part of the operation input unit and the execution unit, the main memory, the storage unit, the I/O, the system bus, the GPU, the video memory, and the graphic bus are device resources. At least some such device resources are commonly operated via operations of the operation input unit and the execution unit.

Subsequently, the CPU, which is a part of the virtual processing unit, executes the processing using the device resources described above, which is inputted via the operation input unit in accordance with the virtual processing program deployed in the main memory in an intermittent manner without actual inputs. More specifically, the virtual processing program grants to the execution program relevant parameters based on virtual inputs that can be inputted and executes relevant processing.

The time measurement program that comprises the time measurement unit calculates the variance between the processing commencement time and the processing completion time via the virtual processing unit, and measures the virtual operation processing time.

### Processing Flow of First Embodiment

FIG. 3 is a flowchart showing an example of the processing flow in the electronic device of the first embodiment. (a) shows the overall processing flow. (b) and (c) show processing flow details for each step. In addition, the steps described below may be the steps executed by hardware configurations of the computer outlined above or may be processing steps that employ the programs recorded on media for controlling the computer.

FIG. 3 (a) is referred to. The processing flow for the electronic device of the first embodiment comprises a virtual processing step (0301) and a time measurement step (0302).

FIG. 3 (b) is referred to. First of all, the virtual processing step involves virtual operation inputs that can be inputted via the operation input unit and execution of virtual processing using the device resources based on the aforementioned operation inputs. The commencement time and the completion time for the aforementioned processing are used in the next time measurement step. Input operations that are virtually processed via the virtual processing step are preferably operations that are highly likely to be inputted via the operation input unit. Therefore, it is desirable that the virtual processing step contain steps for determining what virtual inputs should be processed.

FIG. 3 (c) is referred to. Subsequently, when virtual processing commences via the the virtual processing step, the time measurement step obtains the time for commencement of virtual operation processing and stores the same. Next, when virtual processing completes via the virtual processing step, the variance between the virtual processing completion time and the virtual operation processing commencement time is computed. In some situations, the average value of the virtual operation processing time for a plurality of virtual operation inputs is computed and the virtual operation processing time is measured.

The steps mentioned above are repeated in an intermittent manner.

### Effects of First Embodiment

The electronic device of the first embodiment allowing comprehensive consideration of resource conditions that have an impact on response time for operations can be provided.

As an example, if the virtual operation processing time is remarkably long, users cannot obtain comfort with operations. Thus, if the operation processing time is remarkably long, it is preferable to make relevant responses so that the operation processing time is shortened. Response methods according to the first embodiment are not particularly limited. For example, partial limitation of device functions or display of a warning that urges administrators to make relevant responses are also possible.

As described above, for example, it is possible to impart comfort with operations to users via the corresponding technology.

### Second Embodiment

### Concept of Second Embodiment

An electronic device of a second embodiment is based on the first embodiment. According to the first embodiment, user comfort with operations is not limited by the way in which results of measurement of the virtual operation processing time are used. The electronic device of the second embodiment is characterized in that user comfort with operations can be imparted, for example, in a manner such that resources are distributed so as to be adjustable in accordance with the operation processing time as target time.

### Functional Configuration of Second Embodiment

FIG. 4 is a diagram explicating an example of a functional block for the electronic device of the second embodiment. The functional configuration for the electronic device of the second embodiment is explained hereinafter with reference to this figure.

The electronic device (0401) of the second embodiment comprises an “operation input unit” (0402), an “execution unit” (0403), “device resources” (nor illustrated), a “virtual processing unit” (0404), a “time measurement unit” (0405), an “operation processing time comparison unit” (0406), and a “load control unit” (0407).

Explanations about the operation input unit, the execution unit, the device resources, the virtual processing unit, and the time measurement unit are the same as those described in connection with the first embodiment. Thus, such explanations are omitted.

The “operation processing time comparison unit” retains a function for comparing the virtual operation processing time and the operation processing time as target time. The “virtual operation processing time” is obtained as a result of measurement via the time measurement unit, as outlined above. The “operation processing time as target time” is the target time at which processing inputted via the operation input unit to be executed using the device resources outlined above should take place. The operation processing time as target time is the time permissible for imparting comfort with operations to users. Such time may differ depending on types of virtual inputs, or may be the same for all such inputs.

The “load control unit” distributes resources based on comparison results via the operation processing time comparison unit. The expression “ . . . distributes resources” refers to cases in which CPU, HDD data transmission quantity, main memory (RAM), RAM bandwidth, system bus bandwidth, video memory (VRAM), VRAM bandwidth, graphic bus bandwidth, and the like are assigned to operational procedures for processing of input operations and other types of processing. Examples include distribution of CPU usage. However, it is not necessary to distribute resources based on the comparison results for all of the elements illustrated above. Alternatively, it is acceptable to distribute resources based on the comparison results for elements other than those illustrated above.

FIG. 5 is a graph schematically showing an example of measurement results achieved via the time measurement unit. The dotted line in the figure shows the operation processing time as target time. A specific example using an electronic device with video communication functions is explicated. For the point “p” potion, the virtual operation processing time is longer than the operation processing time as target time (due to lack of resources). Therefore, the resources will be distributed to a much greater extent in order to execute operation inputs. For example, during video communication, resources for operation processing increase due to lowering of the bit rate, and the operation processing time becomes shorter. For the point “q” potions, the virtual operation processing time is shorter than the operation processing time as target time (due to excessive resources). Therefore, resources for execution of operation inputs will be decreased, and distribution will take place for other functions. For example, the bit rate for video communication may be increased. In such case, it is possible to enhance user satisfaction with other functions. For example, image quality can be improved by increasing the bit rate for video communication. The term “bit rate” refers to the number of frames or/and the number of pixels per second upon video communication of images.

### Hardware Configuration of Second Embodiment

A functional configuration for the electronic device of the second embodiment is explained hereinafter. Explanations about the operation input unit, the execution unit, the device resources, the virtual processing unit, and time measurement unit are the same as those described in connection with the first embodiment. Thus, such explanations are omitted.

The CPU, which is a part of the operation processing time comparison unit, compares the virtual operation processing time obtained via the time measurement unit deployed in the main memory with the operation processing time as target time, which can be referred to via the table stored in the media. The comparison results are stored in the main memory.

The CPU, which is a part of the load control unit, obtains the comparison results via the operation processing time comparison unit in the main memory and distributes resources based on such comparison results.

### Processing Flow of Second Embodiment

FIG. 6 is a diagram explicating the processing flow of the electronic device of the second embodiment. (a) shows the overall processing flow. (b) shows an example of processing flow via an operation processing time comparison step and a load control step, representing an electronic device (which is configured to be able to increase and decrease resources as a result of high and low bit rate, respectively) retaining video communication functions as an example.

FIG. 6 (a) is referred to. The processing flow of the electronic device of the second embodiment comprises a virtual processing step (0601), a time measurement step (0602), an operation processing time comparison step (0603), and a load control step (0604). Explanations about the virtual processing step and the time measurement step are the same as those described in connection with the first embodiment. Thus, such explanations are omitted.

FIG. 6 (b) is referred to. The operation processing time comparison step determines whether or not the variance between the virtual operation processing time computed via the time measurement step and the operation processing time as target time falls below a relevant threshold. In case that the virtual operation processing time is longer than the operation processing time as target time, the load control step lowers the bit rate for video communication. On the other hand, in case that the virtual operation processing time is shorter than the operation processing time as target time, the load control step increases the bit rate for video communication. The processing of FIG. 6 (b) is repeated.

### Effects of Second Embodiment

According to the electronic device of the second embodiment, appropriate resource distribution can be achieved with comprehensive consideration of resource conditions that have an impact on response time for operations. As a result, it is possible to impart comfort with operations to users without any failure of the electronic device, for example.

### Third Embodiment

### Concept of Third Embodiment

An electronic device of a third embodiment is based on the second embodiment. With the electronic device described in the second embodiment, it is not always essential to establish the operation processing time as target time, and it is acceptable to set the operation processing time as target time in advance and to retain such time in the electronic device. On the other hand, with the electronic device of the third embodiment, it is possible to set the operation processing time as target time using a target operation processing time setup unit according to circumstances. As a result, it is possible to establish a longer response time for operations in some cases. Resources can be distributed to other functions during the aforementioned time, thereby allowing user satisfaction to be enhanced.

### Functional Configuration of Third Embodiment

FIG. 7 is a diagram explicating an example of a functional block for the electronic device of the third embodiment. The functional configuration for the electronic device of the third embodiment is explained with reference to this figure.

The electronic device (0701) of the third embodiment comprises an operation input unit (0702), an execution unit (0703), device resources (not illustrated), a virtual processing unit (0704), a time measurement unit (0705), an operation processing time comparison unit (0706), a load control unit (0707), and a target operation processing time setup unit (0708).

Explanations about the operation input unit, the execution unit, the device resources, the virtual processing unit, the time measurement unit, the operation processing time comparison unit, and the load control unit are the same as those described in connection with the first or the second embodiment. Thus, such explanations are omitted.

The “target operation processing time setup unit” retains a function for establishment of the operation processing time as target time. For example, such operation processing time as target time may be established based on the functions of devices being operated via the execution unit. Examples include cases in which the operation processing time as target time is established so as to be relatively short during running of word processing software and cases in which the operation processing time as target time is established so as to be relatively long during television viewing. Alternatively, because inputs via a remote control tend to be more frequent during television viewing, the operation processing time as target time may be established so as to be short for input operations that have been inputted via a remote control. Furthermore, when users perform operation inputs, it is highly probable that operation inputs will continue to take place. Thus, when users have performed operation inputs, the operation processing time as target time is set so as to be short. When operations have not taken place for a certain period, the operation processing time as target time is set so as to be long.

If the operation processing time as target time is short, for example, prompt responses can be made in response to user input operations. Thus, it becomes possible to impart comfort with operations to users. Moreover, the operation processing time as target time can be set so as to be longer to an extent that will not cause user comfort to decline, and resources can be distributed to other functions. In such a case, it is possible to enhance user satisfaction.

### Hardware Configuration of Third Embodiment

A functional configuration for the electronic device of the third embodiment is explained hereinafter. Explanations about the operation input unit, the execution unit, the device resources, the virtual processing unit, the time measurement unit, the operation processing time comparison unit, and the load control unit are the same as those described in connection with the first or the second embodiment. Thus, such explanations are omitted.

The CPU, which is a part of the target operation processing time setup unit, establishes the operation processing time as target time in accordance with the program for setup of the operation processing time as target time deployed in the main memory. Such operation processing time as target time is applied via the operation processing time comparison unit.

### Processing Flow of Third Embodiment

FIG. 8 is a diagram explicating the processing flow of the electronic device of the third embodiment. (a) shows the overall processing flow. (b) shows a specific example of processing flow via a target operation processing time setup unit.

FIG. 8 (a) is referred to. The processing flow of the electronic device of the third embodiment comprises a virtual processing step (0801), a time measurement step (0802), a step for setup of the operation processing time as target time (0805), an operation processing time comparison step (0803), and a load control step (0804). Explanations about the time measurement step, the execution unit, the operation processing time comparison step, and the load control step are the same as those described in connection with the first or the second embodiment. Thus, such explanations are omitted.

When operations are not performed for a certain period, the step for setup of the operation processing time as target time establishes the operation processing time as target time during non-operation, which is the operation processing time as target time. On the other hand, when operations have been performed, the operation processing time as target time during operation is established as the operation processing time as target time. The operation processing time as target time during non-operation is preferably set so as to be longer than the operation processing time as target time during operation. This is because it is recognized that once operations have been performed, it is highly probable that such operations will continue to be performed. Such operation processing time as target time is applied via the operation processing time comparison step.

### Effects of Third Embodiment

With the electronic device of the third embodiment, it is possible to distribute resources in a more appropriate manner, based on circumstances. As a result, it is possible to impart comfort with operations to users without any failure of the electronic device, for example.

### First Practical Example

A first practical example is an example in which the electronic device of the third embodiment is used for a digital TV (hereinafter, sometimes referred to as “DTV”) with video communication functions. FIG. 9 is an example of a functional block of the digital TV apparatus outlined above.

The digital TV apparatus (0901) of the first practical example comprises an operation input unit (0902), an execution unit (0903), device resources (not illustrated), a virtual processing unit (0904), a time measurement unit (0905), an operation processing time comparison unit (0906), a load control unit (0907), and a target operation processing time setup unit (0908). Furthermore, the digital TV apparatus of the first practical example comprises a tuner, a demodulation unit, a separation unit, a decoder unit for DTV, a display, a speaker, and the like, in order implement digital TV functions. Moreover, the digital TV apparatus of the first practical example comprises a camera, a microphone, an encoder unit, a transmission unit, a reception unit, a decoder unit for video speech, a display (also used with DTV), a speaker (also used with DTV), and the like, in order to implement video communication functions. The load control unit controls the encoder unit and parameters of a self-machine encoder, and it also controls the transmission unit and parameters of a counterpart apparatus. Alternatively, the load control unit may change parameters for processing for the reception unit, the decoder unit for video speech, the demodulation unit, the separation unit, and the decoder unit for DTV.

FIG. 10 is a schematic diagram showing an example of changes of resource distribution rate upon video communication during digital TV viewing.

Upon video communication during digital TV viewing, device resources are distributed to DTV processing for reception and display of digital TV broadcasting and video communication processing for transmission, reception, and display for video communication. Additionally, some device resources are also distributed to operational processing for users' input operations.

With digital TV broadcasting, both standard definition (SD) image quality and high definition (HD) image quality resolution are possible for digital TVs (DTV resolution). During video communication processing, when changes from SD to HD take place regarding digital TV resolution, the resource quantity that is necessary for DTV processing increases. In such cases, for video communication processing, in order to accept the increase of used resource quantity resulting from an increase of the DTV resolution and to maintain the assigned resources for operation processing at a certain level, it is desirable to decrease resource quantity for video communication processing. Furthermore, when operation inputs are accepted via the operation input unit, it is highly probable that operations will continue to be performed. Thus, it is desirable to increase resources for operation processing upon commencement of operations. Therefore, resources for video communication processing can be further decreased. When operations are not performed for a certain period thereafter, operations are considered to have been completed, and resources for operation processing are returned to their original levels again. Assignment of resources for video communication processing then increases. Increase and decrease of resources for video communication processing can be achieved through adjustment of the bit rate.

FIG. 11 is a diagram explicating the difference between the digital TV apparatus of the first practical example and a configuration in which resource distribution takes place via measurement of the CPU utilization rate.

FIG. 11 (a) is referred to. Based on outcomes of measurement of the CPU utilization rate, the bit rate for video communication images is changed so that the CPU utilization rate becomes closer to the target value. However, there exist many elements that have an impact on response time other than the CPU utilization rate. Thus, it is unknown whether or not operation response time falls within a range that allows users to be comfortable with operations. Furthermore, in case that the target value of the CPU utilization rate is fixed as 70%, the bit rate for video communication images is fixed so as to respond to the aforementioned value. Thus, the grade of images will also be fixed.

FIG. 11 (b) is referred to. With the digital TV apparatus of the first practical example, after some representative types of processing are virtually inputted and processed via the virtual processing unit, average value is computed, and virtual operation processing time is measured. Based on the virtual operation processing time, it is possible to perform resource distribution with the use of a value that is close to the actual response time. Therefore, response time becomes faster, such as in the case of OSD drawing processing based on users' operation inputs. Thereby, it becomes possible to impart comfort with operations to users.

Furthermore, when users commence operations, the target operation processing time setup unit establishes 0.3 seconds as the operation processing time as target time (during operation), and it also establishes 1.0 second as the operation processing time as target time (during non-operation). As such, it is possible to establish the operation processing time as target time in accordance with circumstances. In case that resources for operation processing become deficient due to establishment of 0.3 seconds as the operation processing time as target time, the bit rate for video communication images will be lowered. In such case, movement of video communication images is not smooth, and pictures become rough. However, resources for processing of user input operations can be preserved. Thus, user comfort with operations can be obtained. On the other hand, in case that resources for operation processing have become excessive due to establishment of 1.0 second as the operation processing time as target time, the bit rate for video communication images will be increased. Thus, it becomes possible to enhance the grade of video communication images within a scope that does not cause user comfort with operations to decline.

As described above, according to the digital TV apparatus of the first practical example, it is possible for both user comfort with operations and enhancement of the grade of video communication images to coexist without causing failure to the apparatus upon use of video communication functions.

### BRIEF DESCRIPTION OF THE DRAWINGS

FIG. 1 is a diagram explicating an example of a functional block for an electronic device of a first embodiment.

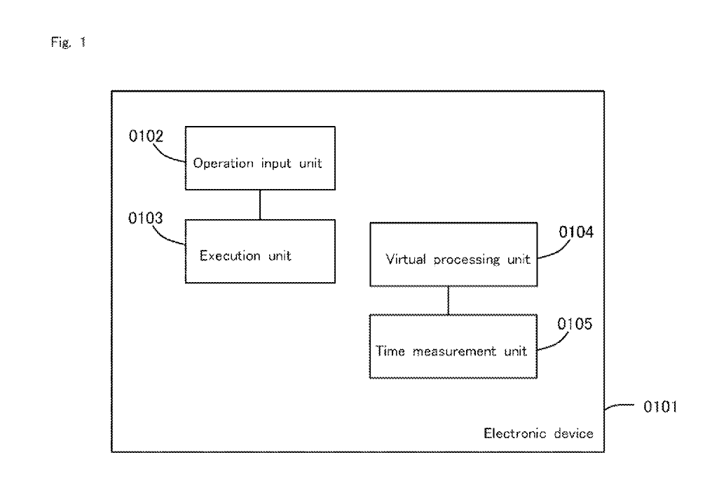

FIG. 2A is a schematic diagram showing an example of a hardware configuration of the electronic device of the first embodiment.

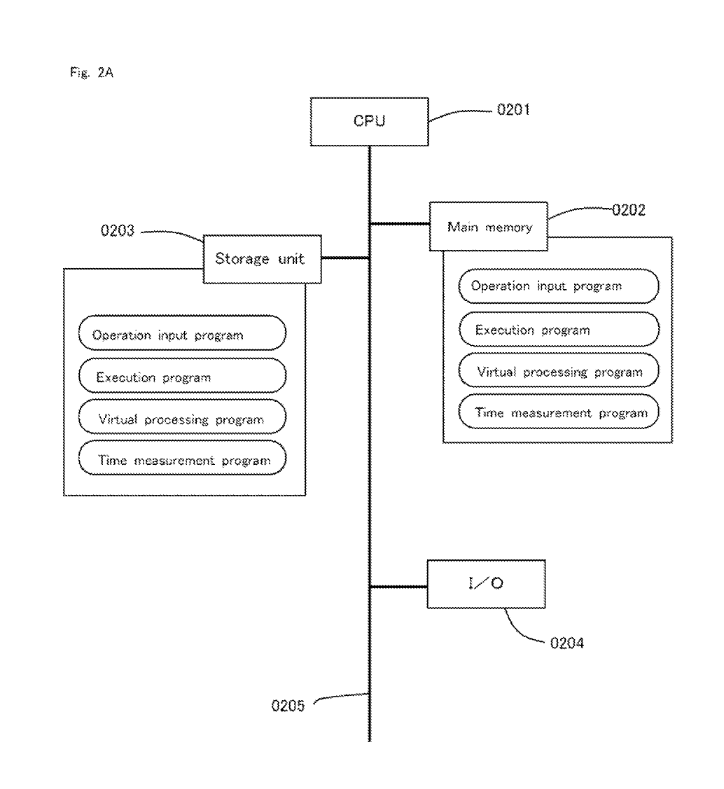

FIG. 2B is a schematic diagram showing an example of a hardware configuration of the electronic device of the first embodiment.

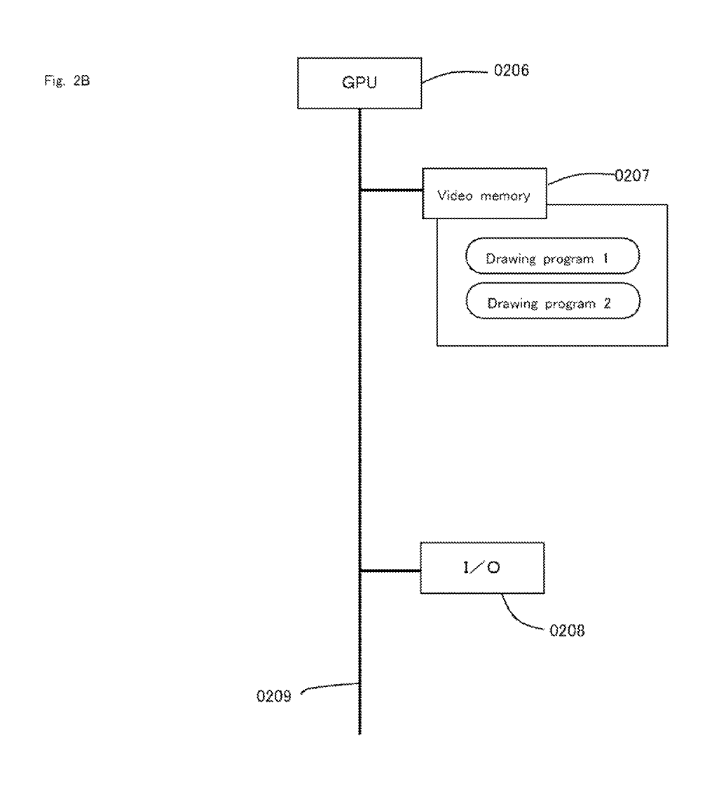

FIG. 3 is a flowchart showing an example of the processing flow in the electronic device of the first embodiment.

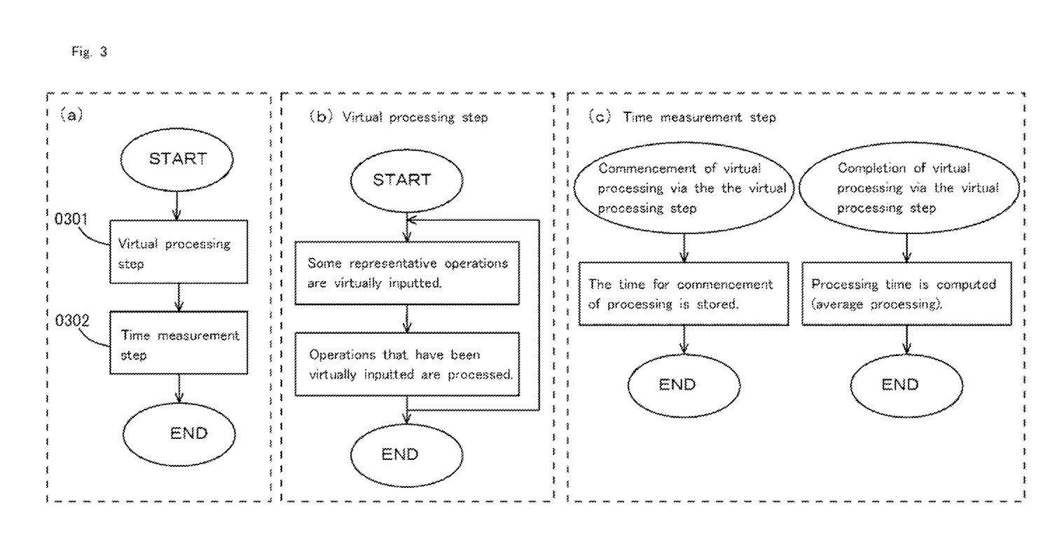

FIG. 4 is a diagram explicating an example of a functional block for an electronic device of a second embodiment.

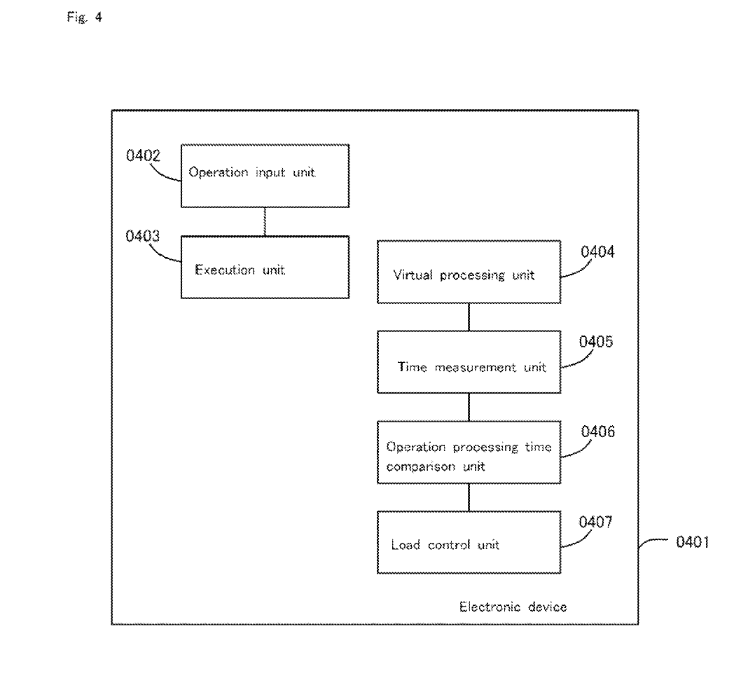

FIG. 5 is a graph schematically showing an example of measurement results achieved via the time measurement unit.

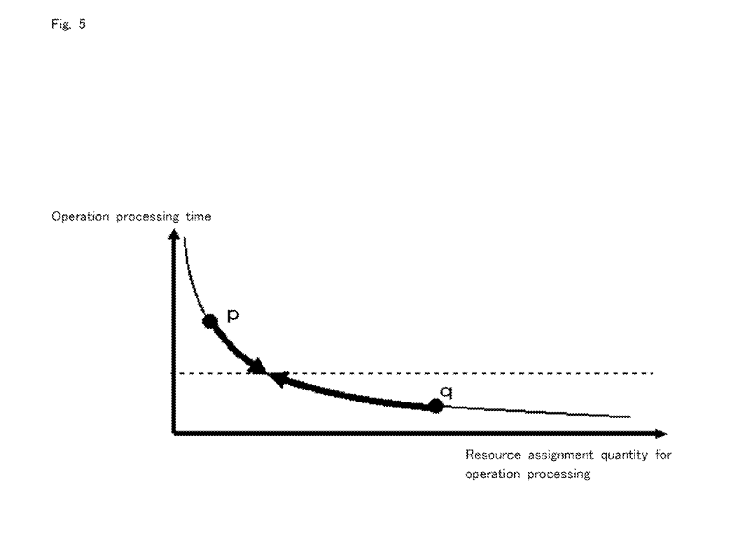

FIG. 6 is a diagram explicating the processing flow of the electronic device of the second embodiment.

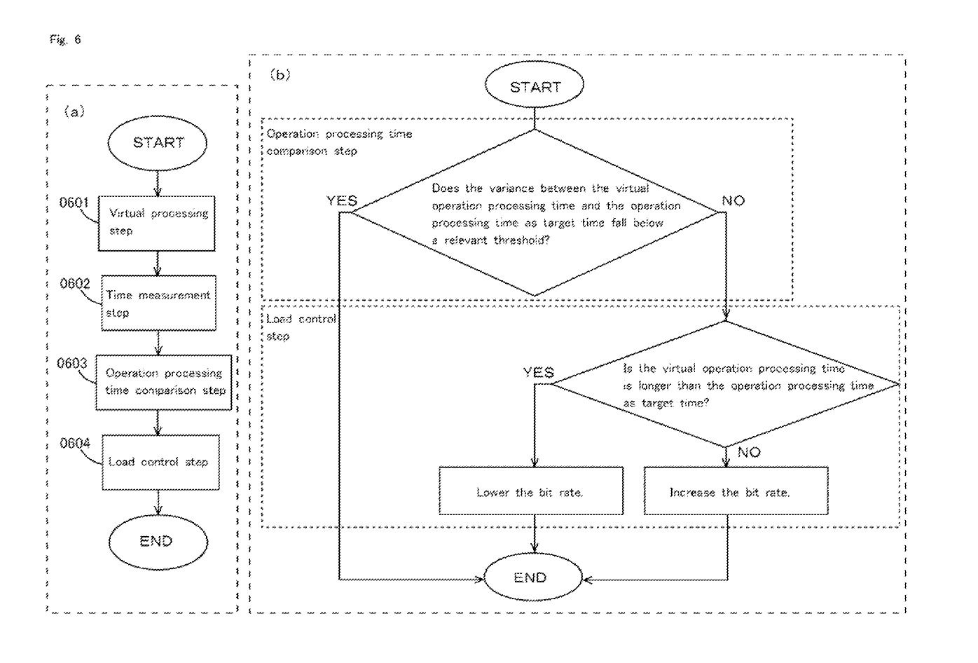

FIG. 7 is a diagram explicating an example of a functional block for an electronic device of a third embodiment.

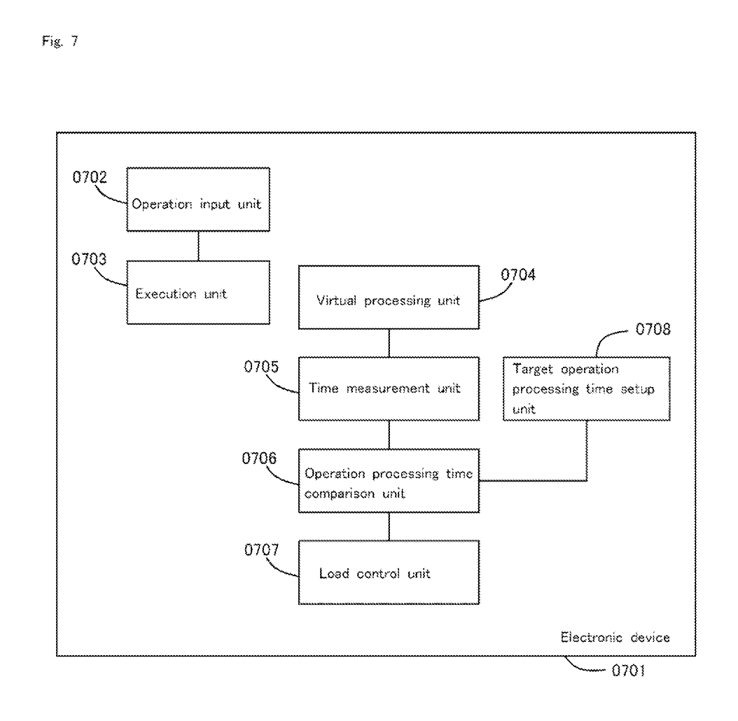

FIG. 8 is a diagram explicating the processing flow of the electronic device of the third embodiment.

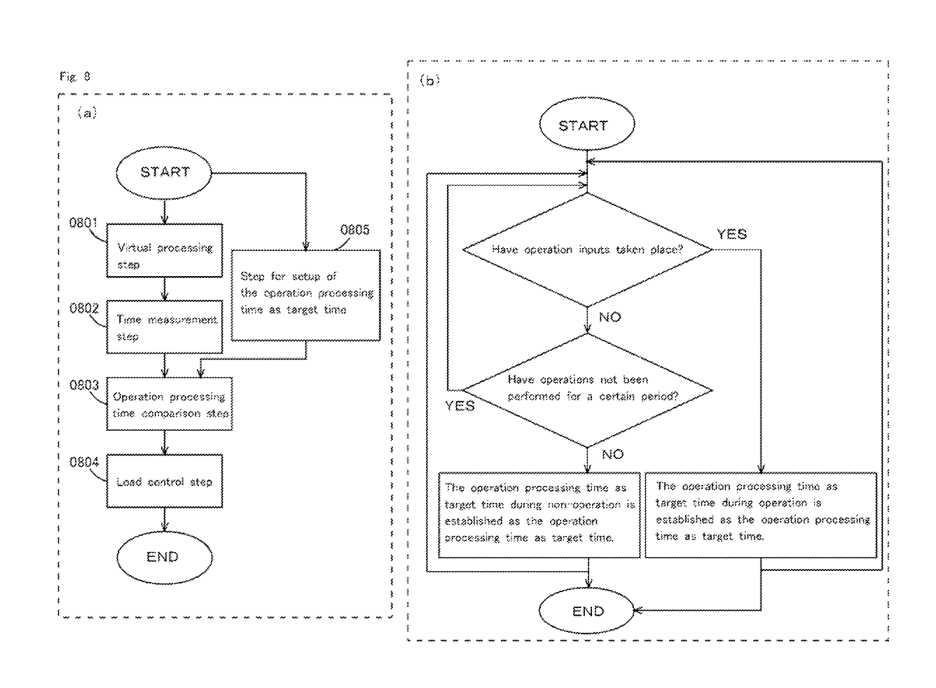

FIG. 9 is an example of a functional block of a digital TV apparatus of a first practical example.

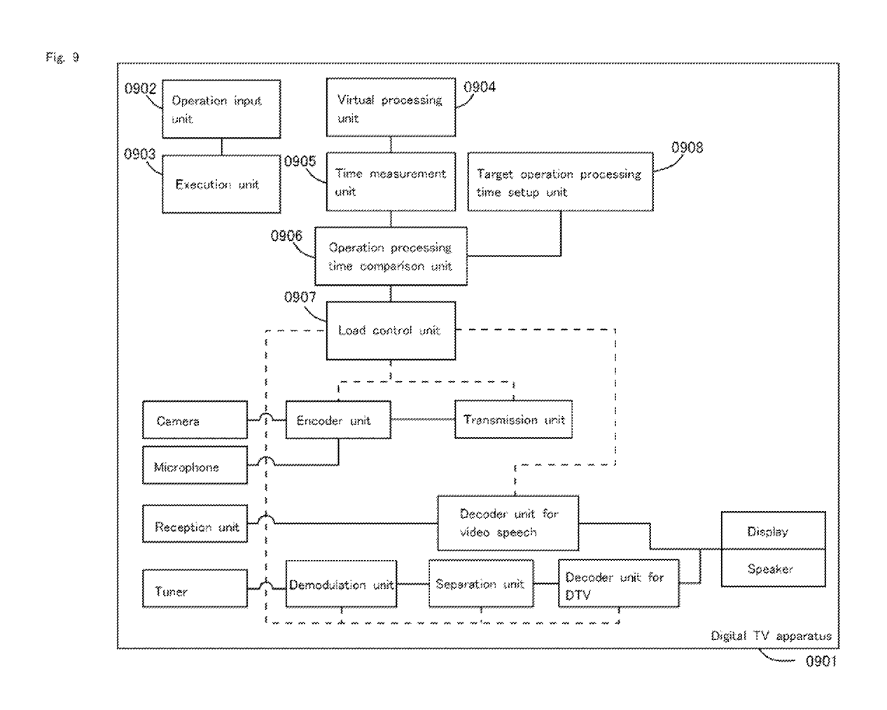

FIG. 10 is a schematic diagram showing an example of changes of resource distribution rate upon video communication during digital TV viewing.

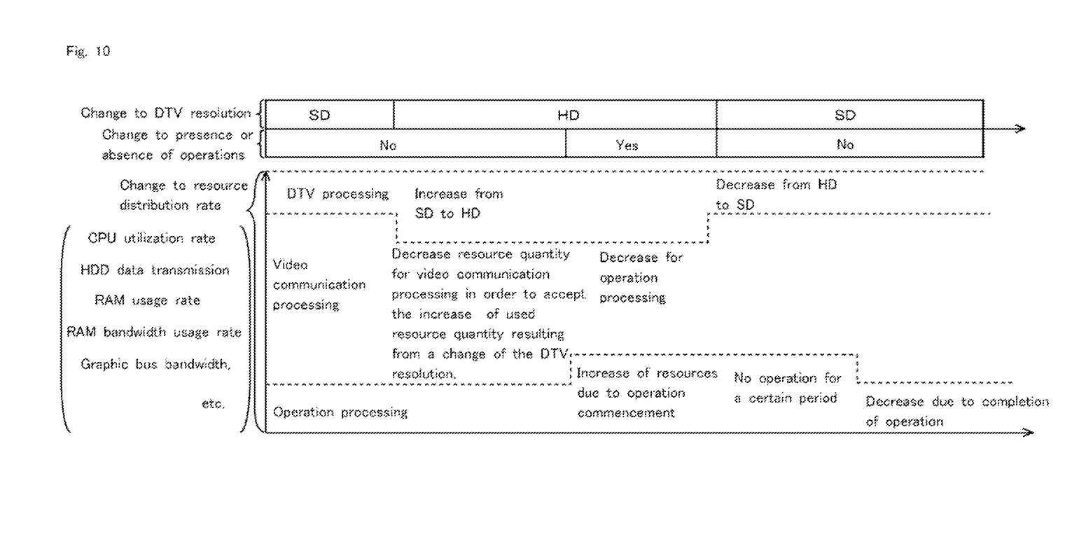

FIG. 11 is a diagram explicating the difference with the digital TV apparatus of the first practical example and configuration in which resource distribution is made via measurement of the CPU utilization rate. FIG. 11 is a diagram explicating the difference between the digital TV apparatus of the first practical example and a configuration in which resource distribution takes place via measurement of the CPU utilization rate.

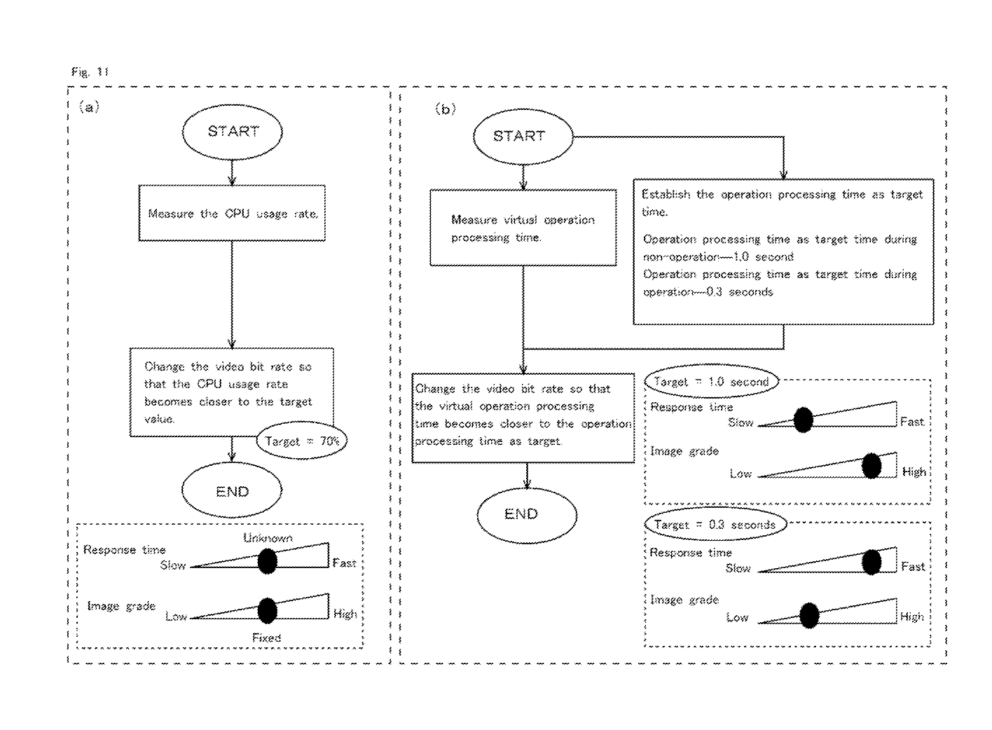

### DESCRIPTION OF REFERENCE NUMERALS

0101 Electronic device
0102 Operation input unit
0103 Execution unit
0104 Virtual processing unit
0105 Time measurement unit
0401 Electronic device
0402 Operation input unit
0403 Execution unit
0404 Virtual processing unit
0405 Time measurement unit
0406 Operation processing time comparison unit
0407 Load control unit
0701 Electronic device
0702 Operation input unit
0703 Execution unit
0704 Virtual processing unit
0705 Time measurement unit
0706 Operation processing time comparison unit
0707 Load control unit
0708 Target operation processing time setup unit

1. An electronic device, comprising:
an operation input unit;
an execution unit for implementing relevant device functions;
a plurality of device resources used via operations of the operation input unit and the execution unit in a shared manner, such device resources influencing operational response time;
a virtual processing unit for executing processes to be executed using the device resources via operations of the operation input unit without actual inputs; and
a time measurement unit for measuring virtual operation processing time required for execution via the virtual processing unit.

2. The electronic device according to claim 1, further comprising
an operation processing time comparison unit for comparing the virtual operation processing time measured via the time measurement unit with operation processing time as target time during which the processes inputted via the operation input unit and via the device resources are executed; and
a load control unit for distributing relevant resources based on the result of comparison via the operation processing time comparison unit.

3. The electronic device according to claim 2, further comprising
a target operation processing time setup unit with functions for establishing the target operation processing time.

4. The electronic device according to claim 1, wherein the operation input unit comprises an input device.

5. A television receiver including the electronic device according to claim 1.

6. The electronic device according to claim 1, wherein functions of the television receiver are television receiving and output functions.

7. The electronic device according to claim 2, wherein such electronic device has video communication device functions and wherein the load control unit distributes relevant resources through adjustment of the bit rate for video communication.

8. The electronic device according to claim 3, wherein the target operation processing time setup unit establishes the operation processing time as target time based on the type of device functions being executed.

9. The electronic device according to claim 3, wherein the target operation processing time setup unit establishes the operation processing time as target time during non-operation, which is the operation processing time as target time, when operations are not performed for a certain period and establishes a shorter operation processing time as target time than the operation processing time as target time during non-operation, which is the operation processing time as target time, when operations have been performed.

10. A process for execution of an electronic device with an operation input unit, an execution unit for implementing relevant device functions, and a plurality of device resources used via operations of the operation input unit and the execution unit in a shared manner, such device resources influencing operational response time and comprising the steps of:
executing processes to be executed using the device resources via operations of the operation input unit without actual inputs; and
measuring virtual operation processing time required for execution via the virtual processing unit.

11. A storage media storing programs for allowing execution of an electronic device with an operation input unit, an execution unit for implementing relevant device functions, and a plurality of device resources used via operations of the operation input unit and the execution unit in a shared manner, such device resources influencing operational response time, such programs causing the computer to execute the steps of:
executing processes to be executed using the device resources via operations of the operation input unit without actual inputs; and
measuring virtual operation processing time required for execution via the virtual processing unit.
